(19) United States
(12) Patent Application Publication
(10) Pub. No.: US 2026/0341073 A1
(43) Pub. Date: Oct. 29, 2026

(54) OPTICAL FINGERPRINT ACQUISITION DEVICE

(71) Applicant: IDEMIA PUBLIC SECURITY FRANCE, Courbevoie (FR)

(72) Inventors: Denis DUMONT, Courbevoie (FR); Sylvain MAILLARD, Courbevoie (FR); Olivier POITELON, Courbevoie (FR)

(73) Assignee: IDEMIA PUBLIC SECURITY FRANCE, Courbevoie (FR)

(21) Appl. No.: 19/461,065

(22) Filed: Jan. 27, 2026

(30) Foreign Application Priority Data
Apr. 24, 2025 (FR) FR2504340

(51) Int. Cl. G06V 40/13; G01N 21/47

(52) U.S. Cl. CPC G06V 40/1324; G01N 21/4738

(57) ABSTRACT

The present invention relates to an optical fingerprint acquisition device (1) comprising:
a light source (S),
an optical plate (2),
imaging means comprising:
   a focusing objective (9);
   a sensor (12);
   a first mirror;
the thickness of the optical plate (2) between the two main faces (3, 4) is greater at the first end (A) than at the second end (B), forming an offset (D), and the device comprises a transparent plate (20) provided with at least two transparent conductive electrodes.

### DESCRIPTION

### Technological Background

The present invention relates to the field of fingerprint capture, and more specifically to improvements made to optical acquisition devices with regard to their securement, notably in the case of fingerprint sensors with contact.

Fingerprint detection devices can, in particular, be used to authenticate a person so that they are authorized to carry out a specific operation: in this case, the fingerprint detection device often accompanies another apparatus that the authenticated person will be authorized to use (computer, banking machine, etc.). The space available for the installation of the fingerprint detection device is thus reduced, and a fortiori the optical acquisition device incorporated in this fingerprint detection device has to be produced in the most compact possible form, and notably with the smallest possible thickness (or height), for example a maximum of 15 mm for an FAP20 image (15.24 mm by 20.32 mm), while providing a secure anti-fake-finger device in particular.

Various embodiments of compact optical acquisition devices intended for the formation of an optical image of fingerprints are already known, including, for example, the device in document EP 1 683 073. However, these known compact devices only image a limited area (less than FAP20, FAP10 for example) and/or do not allow measurement of electrical or electromagnetic characteristics of the finger, in particular for detection of fake fingers, due to a lack of available space, notably for positioning a ribbon connector without reducing the acquisition surface, and in fact do not completely satisfy the practical requirements.

### PRESENTATION OF THE INVENTION

The aim of the invention is to provide an optical fingerprint acquisition device which can be produced in the most compact possible form, and notably with a minimal thickness not exceeding approximately 15 mm, and which is structurally as simple as possible with a minimal number of component elements so that its manufacture and assembly are made as simple, as rapid and as economical as possible, while having means for detecting fraud notably by placement of fake fingers.

For these purposes, the invention provides a compact optical acquisition device capable of forming an optical image of fingerprints.

The terms “upstream” and “downstream” are to be read with reference to the optical path of the light beam, i.e. from the light source to the sensor.

According to one aspect of the invention, what is provided is an optical fingerprint acquisition device comprising:
a light source configured to provide a light beam directed toward a finger, part of the beam being scattered or reflected by the finger,
an optical plate having a first main face and a second main face that are opposite and parallel, a part of said first main face located in the vicinity of a first end of the optical plate constituting an acquisition surface for imaging the finger;
imaging means comprising:
   a sensor;
   a focusing objective;
   a first mirror;
      said device being characterized in that the first main face comprises a second part located between the first part and a second end of the optical plate opposite the first end, the thickness of the optical plate between the two main faces of the optical plate not being uniform, the thickness of the optical plate between said first part of the first main face and the second main face being greater than the thickness of the optical plate between the second part of the first main face and the second main face, forming an offset between said first part and said second part of said first main face, and in that the device comprises a transparent plate provided with at least two transparent conductive electrodes, the electrodes being connected to a ribbon connector, said plate being positioned above said first part of the first main face of the optical plate and projecting with respect to the second part of the first main face of the optical plate, creating an air gap, a face of said plate comprising a surface for placement of a finger. This device makes it possible to provide impedance measurements for the implementation, locally or remotely, of fraud detection by analyzing the impedance of the body placed on the plate. This device also makes it possible to increase the imaged surface for placement of the finger on the plate with respect to the acquisition surface of the optical plate in order to obtain an image of greater dimensions by lengthening the optical path. Furthermore, the offset, creating a step, between the raised first part of the first main face and the second part of the first main face prevents the transparent plate and the optical plate from coupling, the free space created between the optical plate and the plate making it possible to have an air gap between the two and to not impair the properties of total reflection and refraction of each of the faces. Another advantage associated with this structure is that the surface area of the free face of the plate, which is greater than the surface area of the first face of the optical plate, allows more space to effect sealing by applying the sealing strip, and to position the ribbon connector. The term “ribbon connector” notably refers to a flexible electronic connector.

In particular, a part of the face of the plate opposite the face of said plate comprising the surface for placement of a finger is optically coupled with the acquisition surface of the first main face of the optical plate, and a part of the face of said plate comprising the surface for placement of a finger faces the acquisition surface and constitutes the surface for placement of a finger.

Advantageously, the placement surface of the plate and the plate surface optically coupled with the optical plate, and also the acquisition surface of the optical plate, are substantially parallel to each other, thus allowing simplification of the optical design and easy manufacture, notably facilitated bonding. “Substantially parallel” for example refers to a parallelism tolerance of up to 0.05 mm to the plane.

Advantageously, the optical plate is made of synthetic resin, such as polymethyl methacrylate (PMMA), of copolymer or of polycarbonate; the latter two materials having different optical indices make it possible notably to adapt the angle of total reflection depending on the desired image size.

Advantageously, the plate is made of glass, thus making it possible to have a tough, resistant surface in contact with the fingers of the users, while ensuring robust and durable retention of transparent conductive electrodes produced, for example, by an indium tin oxide deposit.

Advantageously, the imaging means, located downstream of the optical plate, are dimensionally within the limits of the thickness of the optical plate, thus making it possible to limit the total thickness of the device.

Advantageously, the device comprises a processing unit, the ribbon connector and the sensor being connected to the processing unit, thus making it possible to process impedance measurements and to detect fraud, notably by placement of fake fingers, locally.

Advantageously, the sensor is integrated into the processing unit which is positioned under the device, thus reinforcing the compactness of the device.

Advantageously, the ribbon connector is connected to the transparent conductive electrodes.

Advantageously, the processing unit is located under the optical plate, thus reinforcing the compactness of the device.

Advantageously, the offset is constituted by a vertical step, thus facilitating the manufacture of the device and making it possible, for example, to position an absorbent element in order to absorb adhesive bleed during the bonding of the plate to the optical plate.

According to one embodiment, the light source and the optical plate are mutually arranged such that the light beam, emitted by the light source and then arriving at the finger placed facing the acquisition surface of the first main face in order to illuminate said finger, then propagates, after reflection and scattering by the finger, inside the optical plate with multiple reflections alternately on the first and second main faces thereof to reach the second end of the optical plate, thus contributing to the compactness of the device by folding of the optical path.

Advantageously, the first and second parts of the first main face and the opposite second main face of the optical plate, and also the face of the plate in contact with the optical plate, are substantially parallel to each other, thus simplifying the optical design.

According to one embodiment, said optical plate has, at its second end, an exit face that is inclined so as to be struck substantially perpendicularly by the light beam; this beveled face, which is cut obliquely, makes it possible for the beam to not be subjected to significant reflection.

Hereinafter, the axis of the focusing objective will be denoted as the optical axis of the imaging means. According to one embodiment, the exit face is oriented such that it forms a tapered protrusion, the first main face and the opposite second main face of the optical plate each forming a base having at least six sides. This construction of the optical plate with a tapered protrusion of the rear lateral face implies notably that said face is no longer entirely in a plane parallel to the front lateral face, nor even entirely in a plane oriented along the transverse axis (y) of the placement surface. This construction makes it possible to lengthen the optical path within minimal available space and to position the angled exit face as close as possible to the first mirror, while keeping space to position the imaging means, notably with the surface area of the first main face smaller than the surface area of the second main face, due to the inclined nature of the exit face.

Advantageously, the point is formed by an obtuse angle between the (upper) edge delimiting the exit face and the first main face and the edge delimiting the first main face and a lateral face of the optical plate and respectively between the (lower) edge delimiting the exit face and the second main face and the edge delimiting the second main face and said lateral face of the optical plate.

Advantageously, the obtuse angle is greater than 100° and lower than 130°, for example equal to 107°, so as to direct the beam exiting the optical plate toward a corner of the device in order to lengthen the optical path while remaining compact.

According to one embodiment, the focusing objective has an entrance surface and an opposite exit surface so as to form a converging lens, the focusing objective being located downstream of the optical plate and being positioned downstream of and facing the first mirror, notably with an optical axis of the focusing objective extending almost parallel to an edge delimiting the exit face and the first main face. This makes it possible to promote compactness and notably to adjust the space between the focusing objective and the two mirrors in order to allow, by construction, focusing on the sensor which is placed as close as possible to the second mirror, reinforcing the efficiency of the converging lens of the focusing objective, intervening in the magnification factor between the finger and its image.

Advantageously, the first mirror has a double inclination, both with respect to the normal to the exit face and with respect to the optical axis of the focusing objective, the first mirror being positioned facing the exit face and facing the entrance surface of said focusing objective and having an orientation such that it receives part of the light beam coming from said exit face and reflects it in the direction of said entrance surface of the focusing objective along the axis thereof, thus allowing the optical path to be folded in a reduced space.

According to one embodiment, said exit face comprises a lens of spherical or aspherical surface, thus making it possible to limit the divergence of the beams while integrating said lens into the exit face so as to optimize the compactness of the device, and to limit the number of specific faces of the optical plate by combining, for example on the same exit face, the beveled cut and said lens. In addition, a magnification factor between the finger and its image is determined by the combination of said entrance and exit surfaces of the focusing objective, forming a converging lens, and this lens of the exit face of the optical plate. Similarly, advantageously, the position of the first mirror is configured in such a way that the distance between the focusing objective and the exit face is such that the lens of said exit face is as large as possible while remaining contained in said exit face.

According to one embodiment, the plate forms a rectangular-based prism, notably a flat parallelepiped, comprising two opposite main faces, namely a first (termed lower) main face optically coupled to the acquisition surface of the first main face of the optical plate, and a second (termed upper) main face part of which faces the acquisition surface and constitutes the surface for placement of a finger, thus making it possible to simplify the optical design of the device and to have a placement surface, which is external and accessible to the user, greater than the facing acquisition surface.

According to one embodiment, the device comprises an outer cover having an opening delimiting the placement surface, a junction between the placement surface and the cover being produced by a sealing strip, thus making it possible for the interior of the device, including in particular the imaging means, to be protected by a cover of which an opening the size of the placement surface will allow the user to place their finger thereon without the risk of contaminating the rest of the device by dust for example.

Advantageously, the main faces of the plate each have a surface greater than the acquisition surface and notably smaller than the surface of the first main face of the optical plate.

According to one embodiment, the placement surface has a surface area greater than or equal to 15.24 mm by 20.32 mm (FAP20), thus meeting the requirements of professionals while being of compact design and then allowing the device, as a module, to be mounted in numerous biometric systems. For example, the placement surface may be 16.7 mm by 21 mm.

Advantageously, the acquisition surface has a surface area smaller than the surface area of the placement surface, notably a surface area smaller than or equal to FAP20.

According to one embodiment, the transparent conductive electrodes are produced by a transparent conductive metallic or oxide deposit, such as a metallic silver deposit, notably as a nanostructure or in the form of grids, or such as a transparent conductive oxide deposit, notably selected from among metal oxides such as silver oxides or from among indium tin oxides (ITO), aluminum zinc oxides (AZO), antimony tin oxides (ATO) and indium zinc oxides (IZO), thus making it possible to supply these plates with a deposit upstream of the rest of the manufacture, notably in the form of large ready-to-cut panels for the manufacture of the device.

According to one embodiment, said first part of the first main face is raised with respect to the second part of said first main face of the optical plate by at least 0.30 mm, preferably between 0.45 mm and 0.65 mm, thus making it possible to create an air gap that prevents coupling of the plate or the ribbon connector with the optical plate.

According to one embodiment, the plate projects longitudinally with respect to the acquisition surface, protruding by a distance d greater than or equal to 2 mm beyond the offset in the direction of the second end, notably between 3 and 5 mm, thus allowing space for the ribbon connector and the seal while increasing the placement surface with respect to the acquisition surface.

According to one embodiment, the plate is bonded to the optical plate, thus allowing easy manufacture by notably positioning the adhesive on the surface of the first part of the first main face of the optical plate and on the surface of the facing plate.

According to one embodiment, the bonding is carried out by means of a flexible and transparent optical adhesive, thus making it possible to absorb the difference in expansion between the optical plate and the plate. Furthermore, the optical adhesive is notably resistant to ultrasound, thus making it possible to ultrasound the plastic cover to ensure its sealing.

According to one embodiment, the device has a thickness lower than or equal to 15 mm, thus making it possible to provide a compact device.

Advantageously, in order to obtain an image of good contrast quality, the optical acquisition device comprises a diaphragm located upstream of and close to the focusing objective.

Advantageously, the device further comprises a second mirror positioned facing the exit surface of said focusing objective and oriented in such a way that the light beam coming from the focusing objective is reflected transversely to the optical plate, thus making it possible to further improve the compactness by folding the optical path notably in order to position a sensor on the same printed circuit as the light source.

Advantageously, the second mirror is oriented in such a way that the light beam is reflected in a direction away from the surface for placement of the finger, thus making it possible to fold the optical path, and notably to position the focusing objective and the sensor in a restricted space, optimizing compactness.

Advantageously, the second mirror belongs to a second projecting part attached to the exit face of the second end of the optical plate, so as to extend in the continuation of said optical plate.

Advantageously, the first mirror belongs to a first projecting part attached to the exit face of the second end of the optical plate, so as to extend in the continuation of the optical plate.

Advantageously, the light source is positioned under the second main face of the optical plate, substantially facing the acquisition surface of the first main face of the optical plate and directed toward the latter, thus making it possible to work on a black background (dark field) rather than a uniform illuminated surface (bright field).

Advantageously, the light source has a wavelength greater than 600 nm, thus making it possible to benefit from the natural scattering of the finger.

Advantageously, the light source is a non-point light source, thus making it possible to improve the uniformity of the illumination, for example with an illumination surface substantially equal to the placement surface.

Advantageously, the light source is a matrix array of light-emitting diodes, with a scatterer interposed between said matrix array and the second main face of the optical plate, thus making it possible to have a large-surface but low-thickness light source that is robust and easy to manufacture.

### PRESENTATION OF THE FIGURES

The invention will be better understood by virtue of the following description, which refers to embodiments and variants according to the present invention that are given by way of non-limiting examples and explained with reference to the appended schematic drawings, in which:

FIG. 1 illustrates a view in longitudinal section of an optical acquisition device arranged in accordance with a possible embodiment of the invention,

FIG. 2 shows a top view of the device in FIG. 1;

FIG. 3 illustrates a top view of the device in FIG. 1 with a representation of the acquisition region;

FIG. 4 is a perspective view of the device in FIG. 1;

FIG. 5 is a perspective view of the device in FIG. 1 with a representation of the acquisition region;

FIG. 6 is an output view of the rear end of the device in FIG. 1; and

FIG. 7 is an example of a schematic of a processing unit for implementing one or more embodiments of the invention.

From one figure to another, identical references will be used to denote elements that are identical or similar in shape or in function.

### DETAILED DESCRIPTION

The invention can be applied in various contexts of enrolment or authentication in order to gain access by means of a terminal for acquiring a fingerprint by contact.

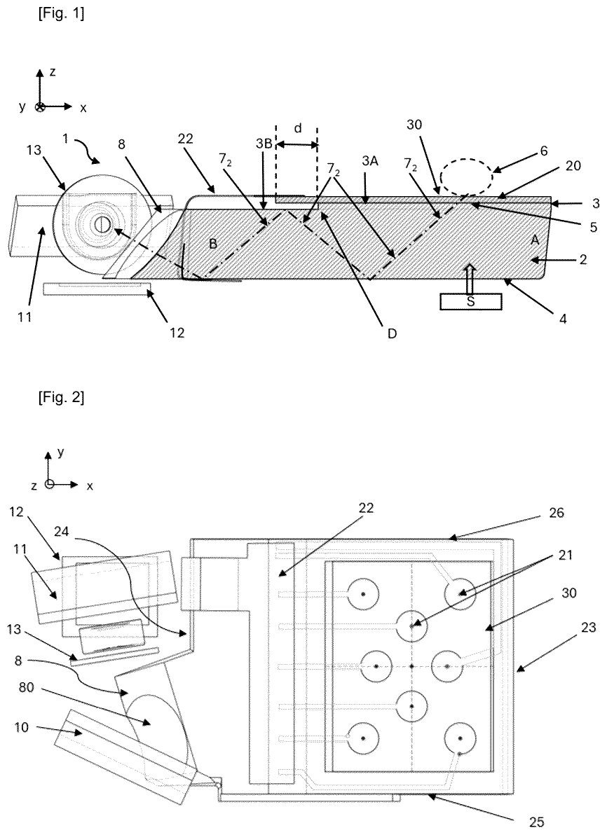

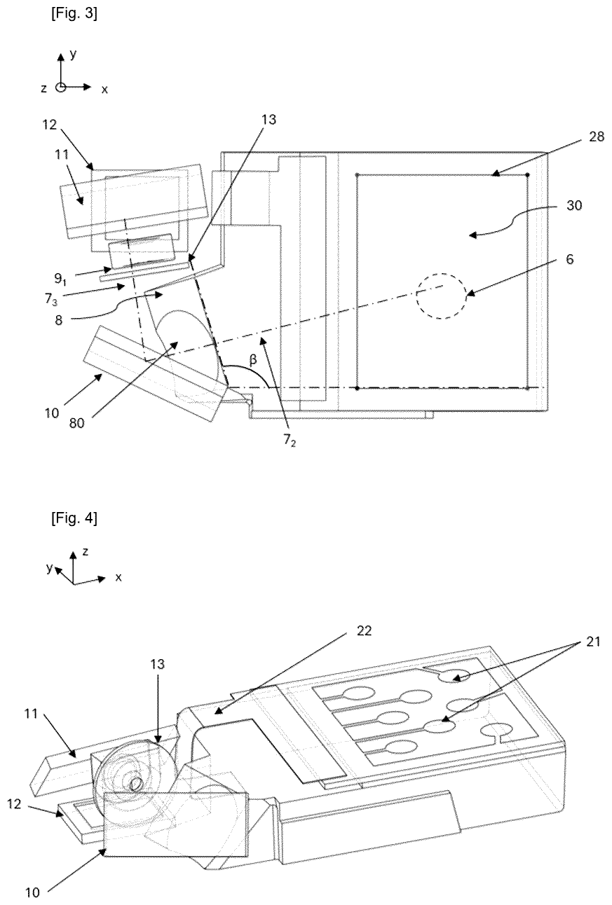

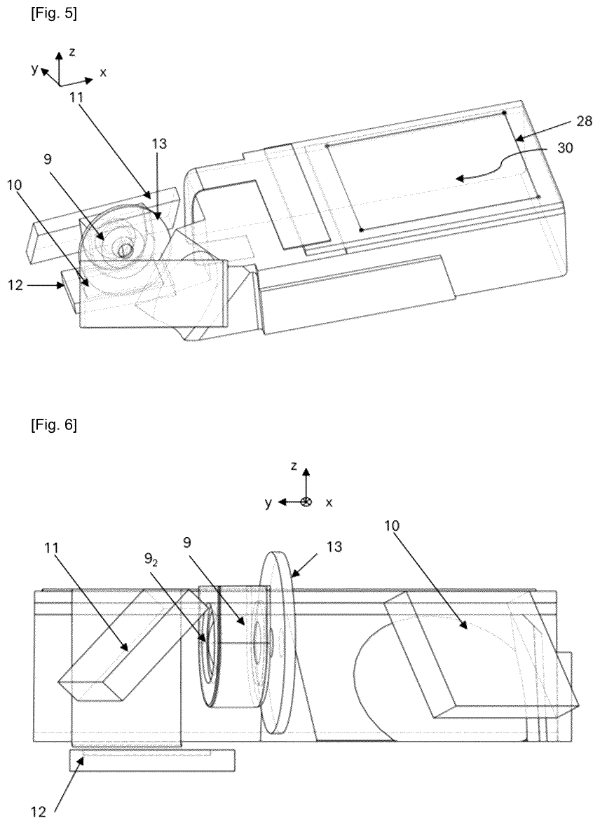

Reference will first of all be made to all of FIGS. 1 to 6 in order to describe a preferred embodiment of an optical fingerprint acquisition device.

In these figures, the axes x and y are defined relative to the surface 30 for placement of the finger which is a rectangle defining the two lateral x and transverse y axes.

The optical fingerprint acquisition device according to the invention, denoted in its entirety by reference 1, mainly comprises:
an optical plate 2;
a light source S;
imaging means comprising:
   a sensor 12;
   a focusing objective 9;
   a first mirror 10;
a transparent plate 20 provided with at least two transparent conductive electrodes 21;
a ribbon connector 22.

This device 1, imager, therefore comprises only a very small number of components, thus making its manufacture easy and inexpensive.

It may also comprise a processing unit 106.

Advantageously, the device 1 comprises an outer cover (not shown) so as to protect the internal components, the cover having an orifice the size of the acquisition surface 5 so that the finger 6 can be placed on the surface 30 for placement of the finger. The overall thickness of the device 1 is advantageously lower than 15 mm; in particular it is 13.65 mm in the embodiment illustrated (including cover and processing unit 106). For example, the thickness of the device as shown in FIG. 1 is approximately 7 mm.

The optical plate 2 is a plate with parallel faces; it behaves like a homogeneous transparent medium, limited by two parallel planar faces. The optical plate 2 therefore does not deflect the light rays which pass through it.

The optical plate 2 is, for example, made of synthetic resin, such as polymethyl methacrylate (PMMA), of copolymer or of polycarbonate. In the embodiment illustrated, the optical plate is made of PMMA, thus allowing homogeneous molding, the material allowing easy injection and exhibiting stable behavior over time. The optical plate 2 has a first main face 3, also termed the upper face, and a second main face 4, termed the lower face, opposite the preceding one. The other faces are called lateral faces, namely a front face 23, notably constituted by a planar, in particular substantially vertical (in the plane yz), surface on the side of the first end A, and a rear face 24 (on the imaging means side), which is advantageously cut out (as described below), on the side of the second end B, and also a left-hand face 25 and a right-hand face 26.

The thickness of the optical plate 2 is non-uniform and forms an offset D between the first part 3A and the second part 3B of the first main face 3. The first part 3A of said first main face 3 located in the vicinity of a first end A (on the right in FIG. 1) of the optical plate comprises an acquisition surface 5 for imaging the finger 6.

In the embodiment illustrated, by construction, non-limitingly, the acquisition surface 5, in the raised first part 3A of the main face 3, is of dimensions substantially smaller than the placement surface 30.

In the embodiment illustrated, the offset D is constituted by a vertical step, other variants being possible such as an inclined plane. The choice of an offset D in the form of a step is advantageous when the manufacture of the device comprises a step of bonding the plate 20 to the optical plate 2 because this makes it possible notably to temporarily position an absorbent element therein in order to absorb any excess adhesive during the bonding.

This offset D makes it possible to not hinder the folding of the optical path in the optical plate 2 by creating a part of the lower surface of the plate 20 which does not couple with the optical plate 2, by virtue of the air gap created between the optical plate 2 and the plate 20 by the offset D, and therefore does not disrupt the reflections in the optical plate 2. Thus, the offset D makes it possible to limit the distance in x between the acquisition surface 5 and the first reflection zone on the top of the optical plate 2.

The two faces 3 and 4 are advantageously—in order to simplify the design of the device both mechanically and in particular optically—parallel to each other, as illustrated in all the figures, between the first face 3—outside the offset D—and the second face 4. Similarly, the first part 3A and the second part 3B of the first main face 3 of the optical plate 2 are parallel to each other.

In the embodiment illustrated, the thickness of the optical plate 2 between the two main faces is greater at the first end A than at the second end B, the thickness of the optical plate 2 between said first part 3A of said first main face 3 and the second main face 4 being greater than the thickness between said second part 3B of said first main face 3 and the second main face 4, in such a way that the acquisition surface 5 is raised with respect to the second part of said first main face 3 and allows the creation of an air gap between the thin plate 20 and the optical plate 2. In this embodiment, the raised first part 3A extends longitudinally to the first end A, and extends transversely as much as the optical plate 2, thus allowing a simple design, but a plate of smaller size could have been envisaged.

Channeling the light beam into the optical plate 2, with multiple reflections on the opposite main faces 3, 4 of the optical plate 2, makes it possible, for a given length of the optical path, to bring the two ends of the optical path closer together, and therefore to produce a shorter and less bulky device. The fact that the two main faces 3, 4 are mutually parallel simplifies the optical design and the manufacture of the optical plate 2. The part 5 corresponding to the acquisition surface of the optical plate 2 is raised with respect to the second part 3B of the first main face 3 by at least 0.30 mm, preferably between 0.45 mm and 0.65 mm. This raised arrangement and the thickness of the plate 20 make it possible to increase the size of the image acquired by lengthening of the optical path compared with a 6-mm optical plate alone, and notably to obtain an FAP20 image, while remaining compact. The difference in thickness depends on the optical path, notably on the thickness of the optical plate 2 and on the number of bounces of the beam, and also on the materials of the plate 20 and of the optical plate 2, while remaining in a limited space. Advantageously, the optical plate 2 has a thickness, between the second part 3B of the first main face 3 and the opposite second main surface 4, greater than or equal to 5.90 mm, preferably 6 mm, depending on the material indices. In the embodiment illustrated, non-limitingly, said thickness is 6 mm, the surfaces 30, 5 and faces 3, 3A, 3B and 4 are parallel, knowing that the parallelism tolerance is 0.05 mm to the plane, the part 5 corresponding to the acquisition surface of the optical plate 2 is raised with respect to the second part 3B of the first main face 3 by 0.55 mm, and the thickness of the plate 20 is 0.55 mm.

The optical plate 2 comprises, at its second end B, in the form of all or part (as shown here) of the rear face 24, a beveled exit face 8, preferably in a plane inclined so as to be struck substantially perpendicularly by the light beam 7₂ so that the latter exits the optical plate 2 via said inclined face 8 without being subjected to significant refraction. Specifically, at normal incidence, the angle of incidence is zero, as is the angle of refraction, so that the direction of propagation is not modified and the optical path is not deflected when crossing the exit face 8. The exit face 8 of the optical plate 2 is therefore notably not vertical but inclined, forming a slope.

Advantageously, the inclined exit face 8 comprises a lens 80 of spherical surface, as shown, or aspherical surface, so as to exploit the refraction and improve the image quality, by creating an additional dioptric interface in addition to the two faces 9₁, 9₂ of the converging lens of the focusing objective 9.

Preferably, but non-limitingly, the lens 80 is a spherical lens integrated into the optical plate 2, thus making it possible to position it as close as possible to the exit face 8 of the optical plate 2 and limiting the number of components for a gain in compactness. In the embodiment illustrated, the exit face 8 of the optical plate 2 comprises a spherical lens 80; this lens 80 is thus directly integrated into the optical plate 2. Preferably, in combination with the inclined nature of the exit face 8 comprising the lens 80, the rear face 24 is cut out, in that it forms a discontinuous surface rather than an entirely planar one, in order to further increase the compactness of the device 1. The exit face 8 therefore constitutes a part of the rear face 24. Specifically, the rear face 24 has a protrusion and a tapered shape in order to position the lens 80 as far as possible from the focusing objective 9, i.e. as early as possible in the optical path, so as to maximize the efficacy of the lens 80. In particular, in the embodiment illustrated, the second end B comprises a protrusion in that the upper and lower edges of the rear face 24 of the optical plate 2 form a point, the shape of the optical plate 2 then approximating an optical plate with a base having at least six sides. Thus, the tapered protrusion supporting the beveled surface 8 gives it its angled shape. In the figures of the illustrated non-limiting embodiment, it can therefore be seen that the upper and lower edges of the exit face 8 are not parallel to the axis y, that is to say that said edges are not parallel to the axis y, but form an obtuse angle β in the plane xy with the upper edge and the lower edge respectively of the left-hand lateral face 25, said exit face 8 delimiting the protrusion of the optical plate 2. In the embodiment illustrated, the exit face is inclined in such a way that the light beam exits the optical plate 2 via said inclined exit face 8 without being subjected to significant reflection and the angle β, here 107 degrees for example, makes it possible to position the lens 80 as early as possible in the optical path, and to cause the rays to no longer exit in the middle of the exit face 8 of the optical plate 2 but on the side, so as to lengthen the optical path and provide more space for the mirrors and the lens, while optimizing compactness.

The light source S is configured to provide a light beam directed toward the finger 6, part of the beam being scattered or reflected by the finger 6.

The light source S and the optical plate 2 are mutually arranged such that the light beam, emitted by the light source S and then arriving at the finger 6 placed on the surface 30 for placement of the finger in order to illuminate said finger 6, then propagates 7₂, i.e. after reflection and scattering by the finger 6, inside the optical plate 2 with multiple reflections alternately on the first 3 and second 4 main faces thereof to reach the second end B of the optical plate 2 opposite the first end A.

Notably, at least one light source S is located facing a face of the optical plate 2, in the vicinity of the first end A thereof, in order to illuminate the finger 6 through the optical plate 2.

In the embodiment illustrated, the illumination of the finger 6 is obtained by positioning a non-point light source S, having a significant surface with respect to the placement surface 30, under the lower face 4 of the optical plate 2, facing said acquisition surface 5 and directed toward it. Advantageously, the illumination surface is close to the surface 30 for placement of the finger. In practice, this light source S can advantageously be a matrix array of light-emitting diodes, notably with a scatterer (for example in the form of a frosting) interposed between the latter and the lower face 4 of the optical plate 2 or formed on said optical plate 2. In non-limiting variants, the illumination source S could comprise several point sources oriented toward the acquisition surface 5, or else could comprise a combination of a light guide with lateral LEDs providing a configuration of the indirect illumination type, notably with curved or inclined lateral surfaces.

The illumination source S may form part of the device 1 or of a terminal on which the device 1 is mounted.

The processing unit 106 may consist solely of an electronic board as shown in FIG. 7. The processing unit 106 is advantageously located under the optical plate 2, thus making it possible to position, on the same electronic board of the unit 106, the light source S, the sensor 12 and a central processing unit implementing notably an algorithm for detecting fraud by analyzing the impedance measured by means of the transparent conductive electrodes 21 of the plate 20 connected to the ribbon connector 22, the ribbon connector being connected to the processing unit 106, notably by connecting the ribbon connector 22 to the conductive electrodes 21. A connector (not shown) is for example under the optical plate 2. The ribbon connector 22 may advantageously be made of a transparent conductive material coated with a transparent insulator, for example a transparent flexible printed circuit board.

The processing unit 106 may form part of the device 1 or of a terminal on which the device 1 is mounted and to which it is electronically connected.

The imaging means shown comprise:
a sensor 12;

### a Focusing Objective 9;

a first mirror 10;
   and are located after the second end B of the optical plate 2. They are located downstream of the optical plate 2 (the optical path following the light, that is to say going from the finger 6 toward the sensor 12).

The focusing objective 9 is located downstream of the optical plate 2.

The first mirror 10 is notably positioned facing the entrance surface 9₁ of said focusing objective 9 and having an orientation such that it receives part of the light beam coming from said exit face 8 at the second end B of the optical plate 2 and reflects 7₃ it in the direction of said entrance surface 9₁ of the focusing objective 9 along the axis thereof. Since the optical axis propagates along the axis 7₂ of the optical plate 2, it enters orthogonally to the exit face 8. In the figures, the optical path 7₃ and the optical axis of the imaging means are shown coincident.

Seen from above, as in FIG. 3, the optical paths are not in the plane of the figure; the optical path 7₂ upon entering the first mirror 10 forms an angle lower than 90° with the optical axis of the imaging means, that is to say to the axis 7₃ of the focusing objective 9, so as to fold the optical path in a minimal space, for optimized compactness. Similarly, the optical axis 7₃ of the focusing objective extends almost parallel to the edge delimiting the junction between the exit face 8 and the first main face 3.

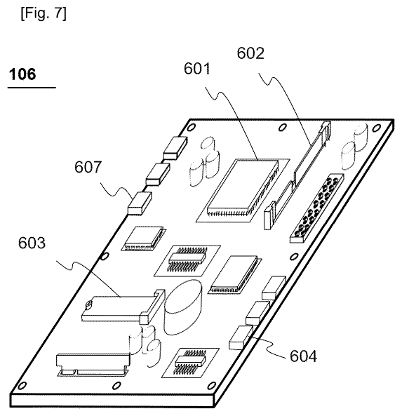

In order for the device 1 to be as thin as possible, it is advantageous, as can be seen more clearly in FIGS. 3 and 6, for the focusing objective 9 to lie within the dimensional limits defined between the two main faces 3, 4 of the optical plate 2, with an optical axis 7₃ for example in the plane xy. The beam having passed through the inclined exit face 8 of the optical plate 2 should then be reflected by the mirror 10 along the axis (coincident with 73) of the focusing objective 9. The mirror 10 deflects the optical path 7₂ at 7₃, thus defining its double inclination, both with respect to the normal to the face 8 and with respect to the axis 7₃ of the focusing objective 9, the mirror 10 being normal to the bisector of the angle formed by 7₂ and 7₃. FIG. 3 shows at 7₂ the path of the beam in the optical plate 2, then at 7₃ after reflection on the mirror 10 and through the focusing objective 9.

The focusing objective 9 (for example in the form of a thick converging lens) has an entrance surface 9₁ receiving the light beam that has passed through the exit face 8 of the optical plate 2 and an exit surface 9₂ from which the focused beam exits; the entrance 9₁ and exit 9₂ surfaces, here both convex, of the focusing objective 9 and also in this case the power of the lens 80 determine a magnification factor between the finger 6 and its image.

Advantageously, the focusing objective 9 is fastened to the optical plate 2, at the end B thereof, by support means (not shown).

In one embodiment, not shown here, the focusing objective 9 may be displaced axially along its optical axis (coincident with 7₃), so as to allow an adjustment of the position of the image focal plane with respect to the sensor 12, this being advantageous when a focus adjustment is necessary.

The diaphragm 13, located upstream and close to the focusing objective 9, makes it possible to limit the influence of stray light and obtain an image of better quality.

The focused beam coming from the focusing objective 9 then reaches the sensor 12 capable of detecting the image of the fingerprints, this sensor being located at the image focal point of the focusing objective. In particular, in the figures, the sensor is not shown, because in order to further increase the compactness of the device 1, the sensor 12 is in this case not located on the optical axis of the focusing objective 9, but under the device 1; the sensor is for example integrated into the processing unit 106 surmounted by the device 1. To this end, a second mirror 11 (embodiment shown) is positioned facing the exit surface 9₂ of the focusing objective 9 and oriented in such a way that the light beam coming from the focusing objective 9 is reflected transversely to the optical plate 2, for example by inclining the second mirror 11 to reflect the beam 7₃ transversely to the optical plate 2 so that the beam then reaches the sensor respecting the Scheimpflug angle. In a case with the sensor located under the device 1, in vertical alignment with the acquisition surface 5, and in particular if the sensor surface is parallel to the acquisition surface 5 under the device 1, the second mirror 11 is oriented so that the light beam is reflected toward the sensor 12.

By virtue of these arrangements, a particularly compact optical acquisition device 1 is formed with the focused beam directed away from the surface 30 for placement of the finger 6.

Advantageously, the first mirror 10 and/or the second mirror 11 may be formed on support parts (not shown) which are attached to the inclined exit face 8 of the optical plate 2, from which they project in the continuation of the optical plate 2. Thus, the first mirror 10 and/or the second mirror 11 may each belong to a projecting part attached to the exit face 8 at the second end B of the optical plate 2, so as to extend in the continuation of the optical plate 2.

According to the explanations above, it will be understood that the projecting parts incorporating the mirrors 10 and 11 respectively, and also the support means of the focusing objective 9, may be produced so as to constitute a device 1 that is very compact and above all has a very small thickness which may not exceed 15 mm, thus meeting the practical requirements.

The transparent plate 20 is for example made of plastic or of glass. In the embodiment illustrated, the plate is made of glass and it is positioned above the acquisition surface 5, the plate 20 being connected to a ribbon connector 22, notably by connecting the ribbon connector 22 to the conductive electrodes 21. The plate 20 is a plate with parallel upper and lower main faces, such as a flat parallelepiped. Non-limitingly, the plate 20 forms a rectangular-based prism. The main faces of the plate 20 have a surface area greater than the surface area of the acquisition surface 5, and notably, non-limitingly, a surface area greater than the surface of the first part 3A of the first main face 3 of the optical plate 2. The plate 20 has an upper surface with dimensions in y lower than 25 mm and in x lower than 30 mm. In the embodiment shown, the dimensions of the plate 20 are 23.6 mm (y) by 24.6 mm (x).

The upper surface of the plate 20 facing the acquisition surface 5 is planar and constitutes a bearing surface for the finger 6, called the surface 30 for placement of the finger 6. The structure of this device according to this embodiment makes it possible to benefit from a surface 30 for placement of the finger, by construction (raised, upstream of the optical path), with a surface area greater than the acquisition surface 5, thus making it possible notably to exploit an imaged surface for placement of the finger that is increased with respect to a lower acquisition surface of the flat optical plate alone, which for example could not have been FAP20. Nevertheless, the invention can also be implemented on the basis of an existing optical plate with an initial acquisition surface greater than FAP20 which would be thinned, with, for example, an acquisition surface which would become smaller but still greater than FAP20.

The periphery of the placement surface 30 of the plate 20 is notably delimited by a sealing strip 28. Specifically, the upper surface of the plate 20 comprising the conductive electrodes constitutes the outer surface of the device 1; the finger 6 of the user is therefore pressed against the latter. The sealing strip 28 is for example made of silicone and it surrounds notably the contour of the placement surface 30 to prevent, for example, the intrusion of dust and/or fluid inside the cover.

The glass plate 20 projects longitudinally with respect to the acquisition surface 5, protruding by a distance d of at least 2 mm, preferably between 3 and 5 mm, beyond the offset D in the direction of the second end B. In the embodiment illustrated, the distance d is 3.6 mm.

The plate 20 is positioned above the acquisition surface 5 by bonding to said acquisition surface 5 of the optical plate 2. Bonding is preferably carried out by means of a transparent adhesive which has an index close to those of the optical plate 2 and/or of the plate 20, and which is notably resistant to ultrasound.

The transparent conductive electrodes 21 are produced by a transparent conductive metallic or oxide deposit, such as a metallic silver deposit, notably as a nanostructure or in the form of grids, or such as a transparent conductive oxide deposit, notably selected from among metal oxides such as silver oxides or from among indium tin oxides (ITO), aluminum zinc oxides (AZO), antimony tin oxides (ATO) and indium zinc oxides (IZO). They are used for impedance measurement, in order to detect fake fingers. At least two electrodes 21 are required to carry out the impedance measurement (one emitter and one receiver), the number of electrodes 21 being able to be increased in order to multiply the impedance measurement points with at least one emitting electrode and several receivers, as shown. In the embodiment illustrated, the glass plate 20 provided with electrodes is coated with a deposit of indium tin oxide and called an indium tin oxide (ITO) plate.

The electrodes are connected to the ribbon connector 22 via the connection tracks, which are notably made of the same material as the electrodes, and the ribbon connector 22 and the sensor 12 are connected to the processing unit 106. Advantageously, the ribbon connector 22 is a component attached to the glass plate by bonding with an anisotropic adhesive ensuring electrical contact.

FIG. 7 shows an example of a structure of an information processing unit 106 for implementing one or more embodiments of the invention. The information processing unit 106 typically comprises one or more central processing units (CPU) 601, a physical communication module (NET) 604, one or more physical input/output modules 607 for interchanging data with external devices (such as a biometric terminal or a computer), a transient storage medium 602 such as a random access memory (RAM), a non-transient recording medium 603 (FLASH) and communication buses (not shown) for transferring data between the internal components of the information processing device 106.

The information processing unit 106 makes it possible to execute one or more programs comprising instructions which, when the program module or modules are executed, cause the information processing unit 106 to implement an algorithm for detecting fraud by impedance analysis. Furthermore, the processing unit 106 may contain a program comprising instructions which, when executed, cause the processing unit 106 to implement a fingerprint recognition algorithm.

The program module or modules may be written in any, compiled or interpreted, programming language. They may form part of a software solution, i.e. of a collection of executable instructions, of codes, of scripts or the like and/or of databases.

The information processing unit 106 comprises the following elements, connected to each other via a communication bus:
a central processing unit (CPU) 601, such as a microprocessor;
a transient memory 602, to store executable code;
a non-transient memory 603 to store computer programs and, if necessary, print templates;
a communication module 604 comprising for example a USB interface 604 (or in a variant a network interface, Ethernet for example) is connected to a communication network over which digital data to be processed are transmitted or received; the network interface 604 may be a single network interface, or be composed of a set of different network interfaces (for example wired and wireless interfaces or different types of wired or wireless interfaces). Data packets are sent to the network interface for transmission or are read from the network interface for reception under the control of the software application executed in the processor 601;
an input/output module 607 for receiving/sending data from/to external peripherals such as a hard disk, a removable storage medium, etc.

The sensor 12 and the light source S, for example in the form of a matrix array of LEDs, may advantageously be positioned on the printed circuit of the central processing unit 601.

The executable code may be stored in the non-transient memory 603, for example a flash memory or a read-only memory, or on a removable digital medium such as, for example, a disk. According to one variant, the executable code of the programs may be received by means of a communication network, via the network interface 604, in order to be stored in one of the storage means of the information processing device 106, such as the memory 603, before being executed.

The central processing unit 601 is adapted to control and direct execution of the instructions or of segments of software code of the program or programs, which instructions are stored in one of the aforementioned storage means, such as the non-transient memory 603. After being turned on, the CPU 601 is capable of executing instructions from the transient RAM memory 602 that relate to a software application.

According to one embodiment, the information processing unit 106 is only hosted locally. In a variant, the processing may be distributed, the processing unit 106 communicating with at least one other remote unit via the network interface 604. Similarly, all or part of the memory may be physically remote, hosted for example on a remote server.

1. An optical fingerprint acquisition device comprising:
a light source configured to provide a light beam directed toward a finger, part of the beam being scattered or reflected by the finger,
an optical plate having a first main face and a second main face that are opposite and parallel, a first part of said first main face located in the vicinity of a first end of the optical plate comprising an acquisition surface for imaging the finger;
an imaging device comprising:
a sensor;
a focusing objective;
a first mirror;
said device being wherein the first main face comprises a second part located between the first part and a second end of the optical plate opposite the first end, the thickness of the optical plate between the two main faces of the optical plate not being uniform, the thickness of the optical plate between said first part of the first main face and the second main face being greater than the thickness of the optical plate between the second part of the first main face and the second main face, forming an offset between said first part and said second part of said first main face, and in that the device comprises a transparent plate provided with at least two transparent conductive electrodes, the electrodes being connected to a ribbon connector, said plate being positioned above said first part of the first main face of the optical plate and projecting with respect to the second part of the first main face of the optical plate creating, an air gap, a face of said plate comprising a surface for placement of a finger.

2. The optical fingerprint acquisition device as claimed in claim 1, the light source and the optical plate being mutually arranged such that the light beam, emitted by the light source and then arriving at the finger placed facing the acquisition surface of the first main face in order to illuminate said finger, then propagates, after reflection and scattering by the finger, inside the optical plate with multiple reflections alternately on the first and second main faces thereof to reach the second end of the optical plate.

3. The device as claimed in claim 1, said optical plate having, at its second end, an exit face that is inclined so as to be struck substantially perpendicularly by the light beam.

4. The device as claimed in claim 3, the exit face being oriented such that it forms a tapered protrusion, the first main face and the opposite second main face of the optical plate each forming a base having at least six sides.

5. The device as claimed in claim 1, the focusing objective having an entrance surface and an opposite exit surface so as to form a converging lens, the focusing objective being located downstream of the optical plate and being positioned downstream of and facing the first mirror, notably with an optical axis of the focusing objective extending almost parallel to an edge delimiting the exit face and the first main face.

6. The device as claimed in claim 3, said exit face comprising a lens of spherical or aspherical surface.

7. The device as claimed in claim 1, the plate forming a rectangular-based prism, notably a flat parallelepiped, comprising two opposite main faces, namely a first main face optically coupled to the acquisition surface of the first main face of the optical plate, and a second main face part of which faces the acquisition surface and constitutes the surface for placement of a finger.

8. The device as claimed in claim 1, the device comprising an outer cover having an opening delimiting the placement surface, a junction between the placement surface and the cover being produced by a sealing strip.

9. The device as claimed in claim 1, the placement surface having a surface area greater than or equal to 15.24 mm by 20.32 mm.

10. The device as claimed in claim 1, the transparent conductive electrodes being produced by a transparent conductive metallic or oxide deposit, such as a metallic silver deposit, notably as a nanostructure or in the form of grids, or such as a transparent conductive oxide deposit, notably selected from among metal oxides such as silver oxides, as a nanostructure or in the form of grids for example, or from among indium tin oxides, aluminum zinc oxides, antimony tin oxides and indium zinc oxides.

11. The device as claimed in claim 1, the first part of the first main face being raised with respect to the second part of said first main face of the optical plate by at least 0.30 mm, preferably between 0.45 mm and 0.65 mm.

12. The device as claimed in claim 1, the plate projecting longitudinally with respect to the acquisition surface, protruding by a distance d greater than or equal to 2 mm beyond the offset in the direction of the second end (B), notably between 3 and 5 mm.

13. The device as claimed in claim 1, the plate being bonded to the optical plate.

14. The device as claimed in claim 13, the bonding being carried out by a flexible and transparent optical adhesive, which is notably resistant to ultrasound.

15. The device as claimed in claim 1, the device having a thickness lower than or equal to 15 mm.

16. The device as claimed in claim 2, said optical plate having, at its second end, an exit face that is inclined so as to be struck substantially perpendicularly by the light beam.

17. The device as claimed in claim 16, the exit face being oriented such that it forms a tapered protrusion, the first main face and the opposite second main face of the optical plate each forming a base having at least six sides.

18. The device as claimed in claim 2, the focusing objective having an entrance surface and an opposite exit surface so as to form a converging lens, the focusing objective being located downstream of the optical plate and being positioned downstream of and facing the first mirror, notably with an optical axis of the focusing objective extending almost parallel to an edge delimiting the exit face and the first main face.

19. The device as claimed in claim 2, the plate forming a rectangular-based prism, notably a flat parallelepiped, comprising two opposite main faces, namely a first main face optically coupled to the acquisition surface of the first main face of the optical plate, and a second main face part of which faces the acquisition surface and constitutes the surface for placement of a finger.

20. The device as claimed in claim 2, the device comprising an outer cover having an opening delimiting the placement surface, a junction between the placement surface and the cover being produced by a sealing strip.
